(19) United States
(12) Patent Application Publication
(10) Pub. No.: US 2020/0008989 A1
(43) Pub. Date: Jan. 9, 2020

(54) DEVICE FOR HANDLING A HELICOPTER STRETCHER

(71) Applicant: AEREA S.p.A., Turate (Como) (IT)

(72) Inventors: Silvano MANTOVANI, Turate (Como) (IT); Danilo PEZZONI, Turate (Como) (IT)

(73) Assignee: AEREA S.p.A., Turate (Como) (IT)

(21) Appl. No.: 16/458,870

(22) Filed: Jul. 1, 2019

(30) Foreign Application Priority Data
Jul. 5, 2018 (IT) 102018000006972

(51) Int. Cl. A61G 3/02; A61G 3/08

(52) U.S. Cl. CPC A61G 3/0254; A61G 2220/10; A61G 3/029; A61G 3/0875

(57) ABSTRACT

A device for handling a stretcher is suitable to be installed in a helicopter cockpit for displacing the stretcher between a patient transportation position, in which the stretcher is arranged horizontally and parallel to a longitudinal axis of the helicopter, and a patient loading and unloading position in which the stretcher is at least partially removed from the helicopter cockpit substantially transversely to the longitudinal axis, and vice-versa.

### FIELD OF THE INVENTION

The present invention regards a device for handling a helicopter stretcher and, more in particular, a handling device suitable to be installed in a helicopter cockpit for displacing a stretcher between a patient transportation position and patient loading and unloading position.

### STATE OF THE PRIOR ART

The transportation of patients by means of air transportation, in particular by means of a helicopter, is growing considerably due to various factors, for example the extreme quickness of intervention with respect to the road vehicles conditioned by the traffic of the road networks, the ease of access to isolated areas at times even due to natural calamities, the possibility of being able to promptly intervene in arduous areas, mountain areas or during major events, the concentration of specialised expertise in major hospital hubs, etc.

Various health transportation solutions by helicopter have been developed over the years and in particular devices aimed at facilitating the loading and unloading a patient lying on a stretcher into and from a helicopter cockpit have been proposed.

In helicopters provided with a rear hatch it is possible to provide for an action for loading and unloading a patient on a stretcher through such hatch.

Aeronautics safety standards require that, with the helicopter on the ground and with the rotor rotating, that all operators nearing it can work only at one area (front) always staying in the direct visual field of the pilot. This requires to completely shut the machine down during the loading and unloading step, and thus extending the take-off and landing procedure times.

Even more so, the closeness of the tail rotor requires, in this case, the use of machines with the tail rotor protected or intubated, a solution that is more complex and expensive than the conventional one.

The rear area of the cockpit is close to the engine exhaust nozzles, and thus the patient and operators are more likely to inhale harmful gases during the loading and unloading operations.

Due to the different conformation (the feet of the patient are close to the rear hatch), the cockpit is less accessible, and the space beside the legs of the patient is limited. Given that the stretcher lies against the lateral wall of the cockpit, a side of the patient is difficult if not impossible to access whereas any health operations are more challenging.

Possibly, when loading and unloading the patient from the side doors (required in case of operations using the winch or partial hovering) the handling of the patient in the cockpit during these critical and agitated times is extremely challenging due to the narrow spaces and the need to translate and fully rotate the patient so as to place him/her on the designated stretcher, basically lifting and dragging the patient physically.

In machines without the rear hatch instead, the patient is loaded on board from the side doors. In this case, the patient can be arranged both in transversal configuration, with the head near one of the two hatches and in longitudinal configuration. The transversal configuration is the most practical one and quickest to implement both for loading the stretcher on wheels and when manoeuvring the winch or when hovering. However, the size of the machines currently available in the market entails the fact that a lying down medium height/tall adult person fully occupies the width of the cockpit, with the head of the patient, as mentioned, close to a hatch.

This position of the patient hinders or extremely complicates the operators' attempt to perform possible emergency respiratory procedures (tracheal intubation) which, for the best execution thereof, require that the operator be at a position aligned with the patient, looking at him/her from above the head of the patient. This need was addressed by the European standard EN 13718, specifically regarding medical transportation by air, which, though not bin ding for now, outlines the best practice guidelines to be followed when preparing the machines of the new configuration type. Among other things, it defines minimum vacant spaces around the patient so as to provide the medical team with the required space for manoeuvre.

Thus, a solution in which the loading and unloading the stretcher occurs through a side hatch of the helicopter and in which, during transportation, the stretcher is arranged in a configuration parallel to the longitudinal axis of the helicopter, is to be generally considered an advantageous solution.

Such longitudinal transportation configuration entails some criticalities including the need to provide for, when displacing the stretcher from the loading and unloading position to the transportation condition, a trajectory that allows the stretcher not to interfere with the equipment internal structures of the helicopter and simultaneously performing an easy manoeuvre for the operators, while simultaneously guaranteeing the required comfort for the patient lying on the stretcher.

The French patent n° FR 2636523 dated 1988 discloses a movable support for a stretcher to be installed in a helicopter cockpit that provides for the displacement of the stretcher by means of a translation and rotation motion obtained by means of a longitudinal sliding guide and a pair of articulated arms. The combination of the two motions is carried out manually and it can entail erroneous manoeuvres given that no synchronisation of the displacements of the stretcher—which must thus be coordinated by an operator so as to avoid knocking against the obstacles present in the cockpit—is provided for.

The French patent n° FR 2682930 date 1991 regards a support device for s stretcher to be installed on the platform of the helicopter cockpit, designed for the displacement of the stretcher by means of a rotary motion obtained by means of a pair of curved guides, with different curvatures. The support device comprises a mechanical displacement system installed beneath the stretcher, which will thus be at a raised position with respect to the helicopter platform and at a height that is too high to allow the medical personnel to load the patient on board by lifting the latter by hand.

In the international patent application number WO 97/13684 dated 1996 the stretcher is carried by a rotatable platform, installed on the platform of the helicopter, with respect to which the stretcher can oscillate. Even in this case, the displacements of the stretcher are carried out manually, with the ensuing drawbacks outlined above. Furthermore, the inclination of the stretcher, suitable to facilitate the loading and unloading of a patient, entails the risk of the patient slipping and falling off the loading plane. In addition, the patient loading operation occurs by strongly pushing the stretcher on the inclined plane formed by the platform of the loading system, these being rather tiresome and complex operations.

The international patent application n° WO 91/15178A1 describes a framework for supporting a stretcher in a vehicle provided with displacement means which maintain the stretcher horizontal. Such support framework substantially consists in two pairs of support rods connected—at one end—to a support of the rod and—at the other end—to a handling device provided with motor-driven arms. This solution neither allows to guide nor to customise the stretcher displacement trajectory so as not to interfere with the equipment and structures inside the helicopter. Furthermore, such support does not guarantee the stability of the stretcher during transportation.

### SUMMARY OF THE INVENTION

The object of the present invention is to overcome the aforementioned drawbacks.

According to the invention, this object is obtained thanks to a device for handling a helicopter stretcher of the type defined in claim 1.

According to the invention, the vertical displacement device or all the handling means of the support platform of the stretcher can be motor-driven.

According to a further characteristic of the invention, a programmable electronic control unit is arranged to control the handling means and the vertical displacement device so that the translation, rotation and raising-lowering displacements of the stretcher are automated in a synchronized fashion. In this manner, the stretcher displacement trajectory does not interfere with internal equipment or uprights of the helicopter and a continuous and fluid displacement of the stretcher from the transportation position to the lowered loading/unloading position and vice versa can be obtained.

The support platform of the stretcher is conveniently provided with engagement means suitable to be slidably coupled with sliding guides provided for on a horizontal platform of the support structure for the translation and rotation motions of the stretcher.

### BRIEF DESCRIPTION OF THE DRAWINGS

Further characteristics of the invention will be apparent from the following detailed description, with reference to the attached drawings, provided by way of non-limiting example, wherein:

FIG. 1 is a schematic perspective view of an embodiment of the handling device according to the invention represented in a configuration for the transportation of a patient in a helicopter cockpit,

FIGS. 2 to 4 are views similar to FIG. 1 wherein the support platform of the stretcher, represented semi-transparent, moves from the transportation configuration of FIG. 2 to the raised loading and unloading configuration of FIG. 4,

FIG. 4A is a perspective view of the rear part of FIG. 4, seen from the rear,

FIGS. 5 to 7 are views similar to FIG. 4 in which the support platform of the stretcher, represented semi-transparent, is displaced vertically between the raised and lowered loading and unloading positions,

FIG. 5A is a perspective view of the rear part of FIG. 5A, seen from the rear,

FIGS. 8 to 10 are partial enlargements of a distal portion of the handling device according to the invention starting from the transportation configuration.

### DETAILED DESCRIPTION OF THE INVENTION

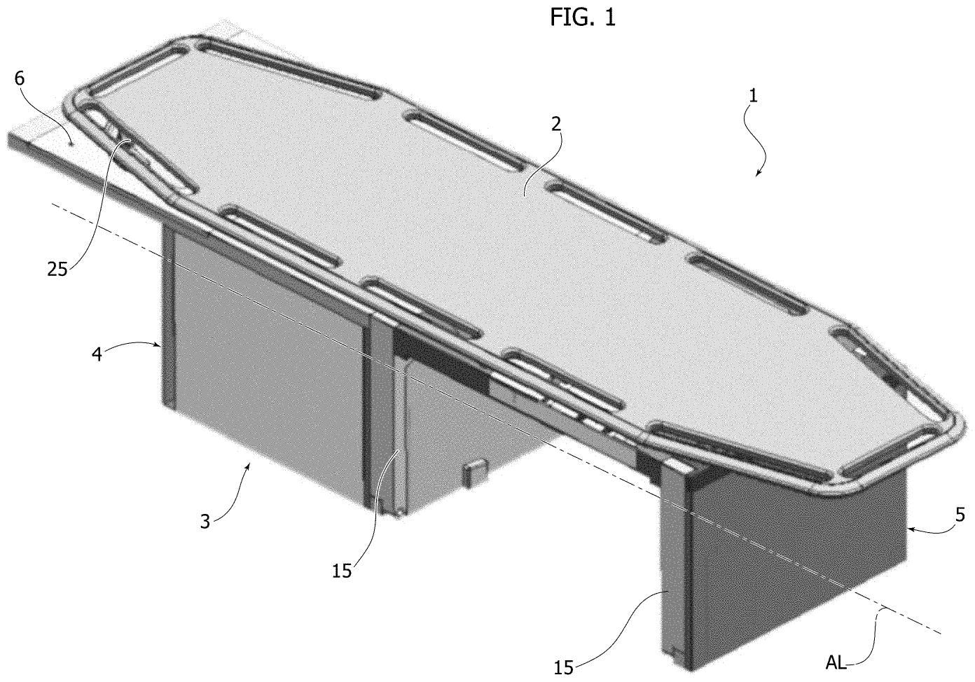

Initially with reference to FIG. 1, a device for handling a helicopter stretcher according to an embodiment of the invention is generally indicated with 1 and it comprises a support platform 2 fixed on which in a generally known manner is a medical stretcher, not represented in the figures, and a support structure 3 of the platform 2.

The support structure 3 is configured to be fixed—at the lower part thereof—to the floor of a helicopter cockpit, not shown, and it comprises a first substantially box-shaped distal portion 4 and—in front of it—a proximal portion 5, including an articulated quadrilateral mechanism which will be addressed hereinafter. The upper part of the proximal and distal portions 4, 5 forms a horizontal platform or plate 6 movably arranged in which is the support platform 2 of the stretcher.

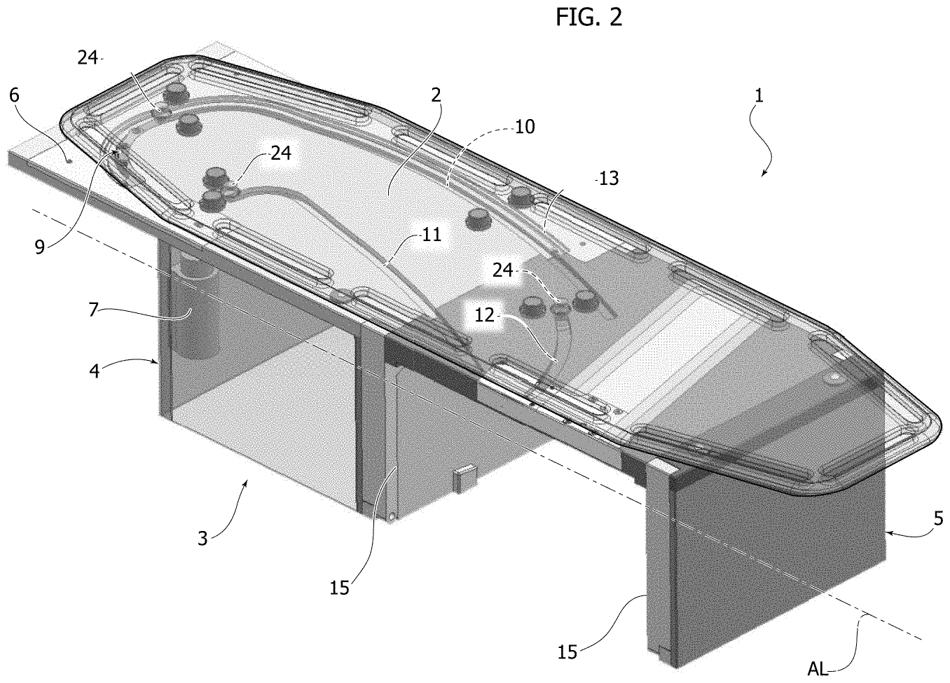

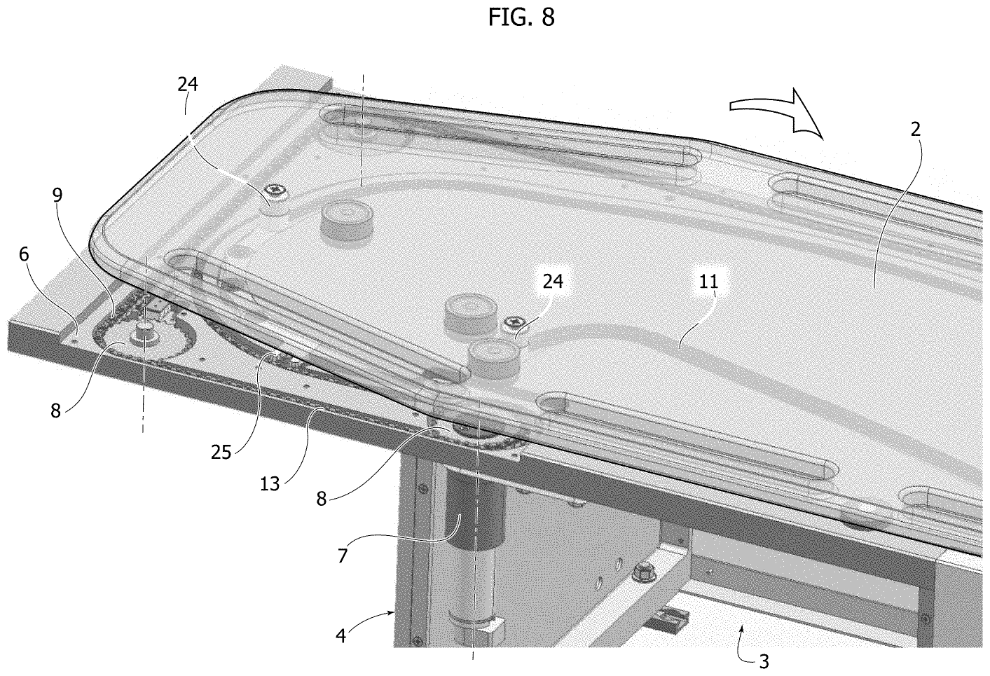

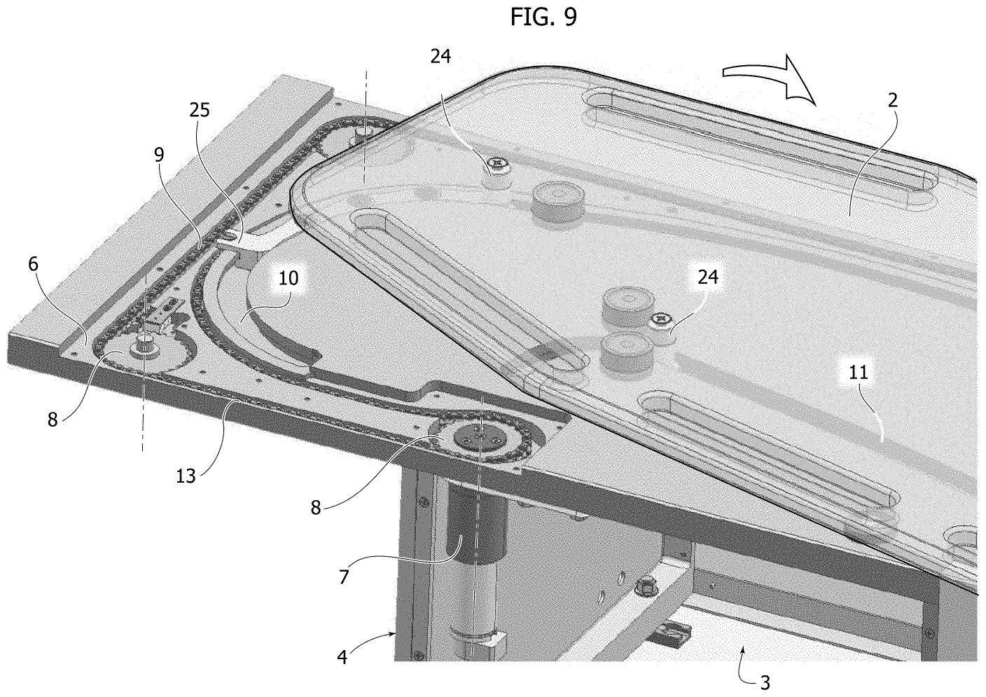

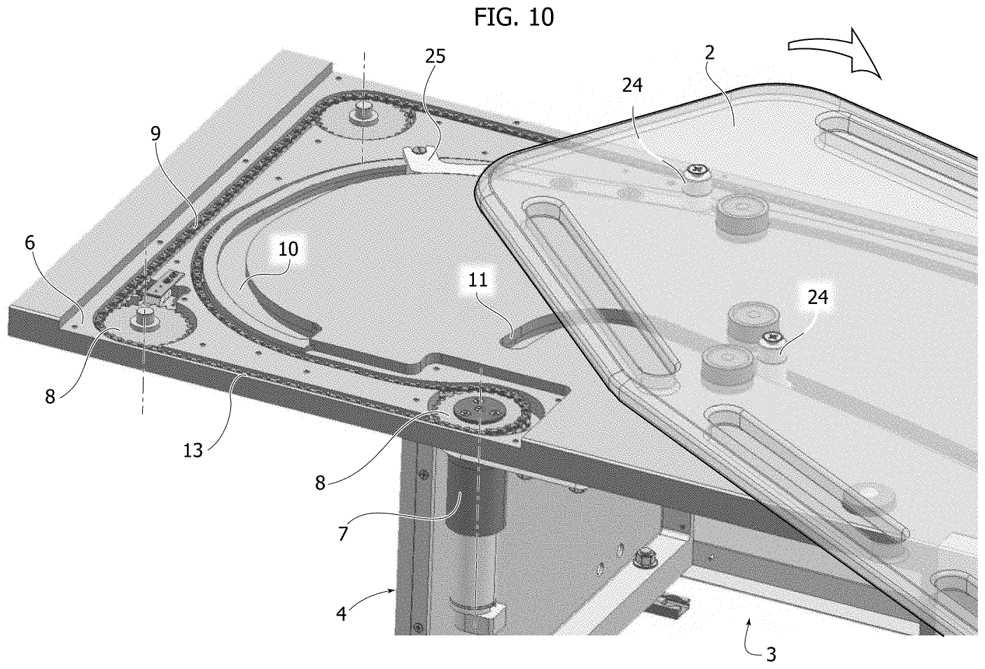

Now, with reference to FIGS. 2 to 4 and 8 to 10 shown are the main means for the translation and rotation motion of the support structure 3 of the stretcher, which comprise an electric motor 7 provided for in the box-shaped portion 4 and designed to control the rotation of a gearwheel 8 engaged with a chain 9. The chain 9 slides in a hollow guide 13 obtained on the upper surface of the horizontal platform 6 it is configured as a closed loop. Further three gearwheels 8 for idling the chain 9 are positioned substantially at the vertices of the closed loop. Three curvilinear sliding guides 10, 11, 12 are obtained on the upper surface of the horizontal platform 6 and they are designed for the slide guiding of a plurality of engagement devices 24 projecting from the lower face of the support platform 2. The chain 9 is removably connected—at a point—to the support platform 2 by means of an articulated bracket 25.

In an embodiment of the handling device according to the invention the translation and rotation motion of the support structure 3 of the stretcher is carried out manually: in this case the electric motor 7 may not be provided.

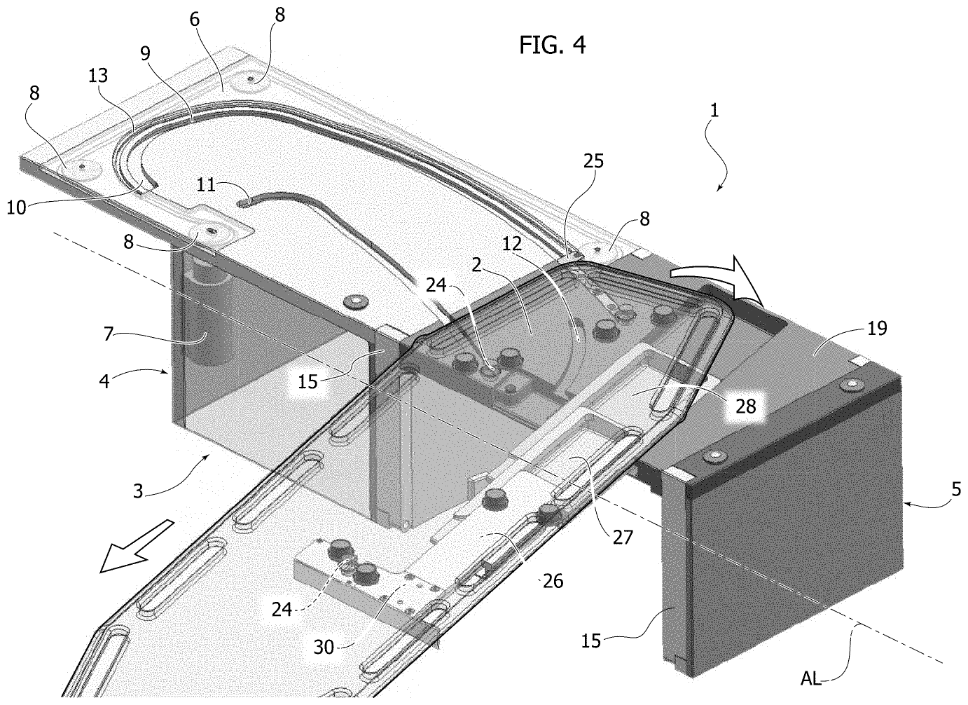

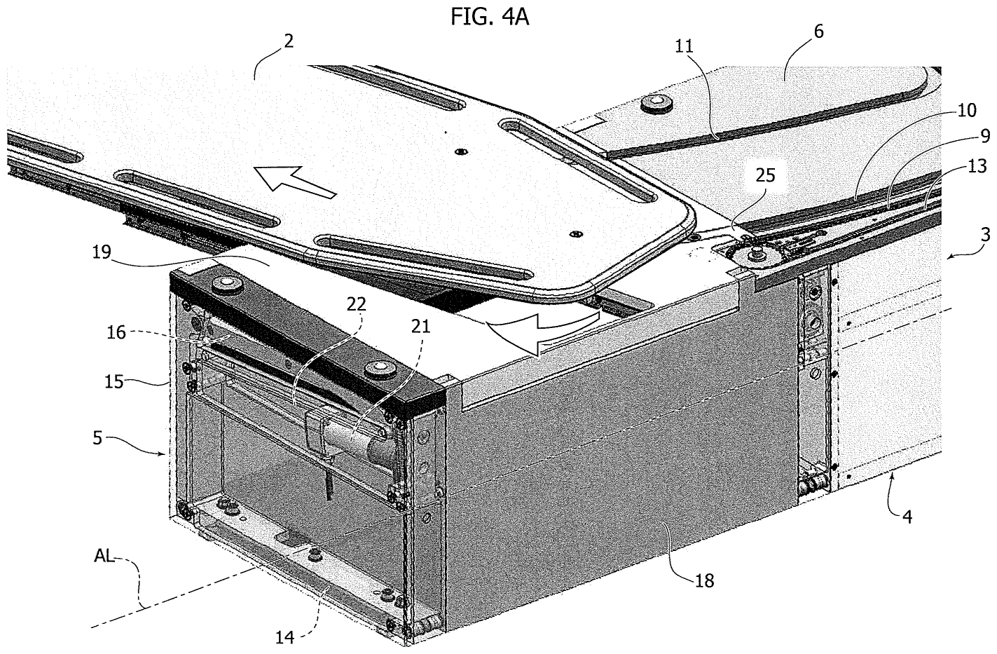

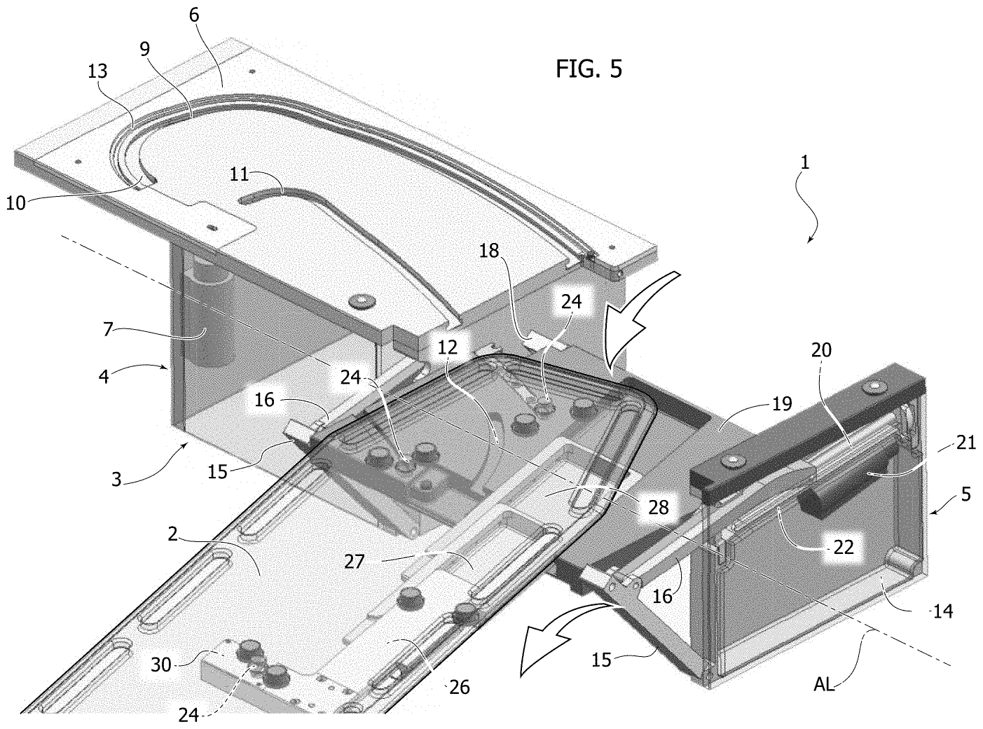

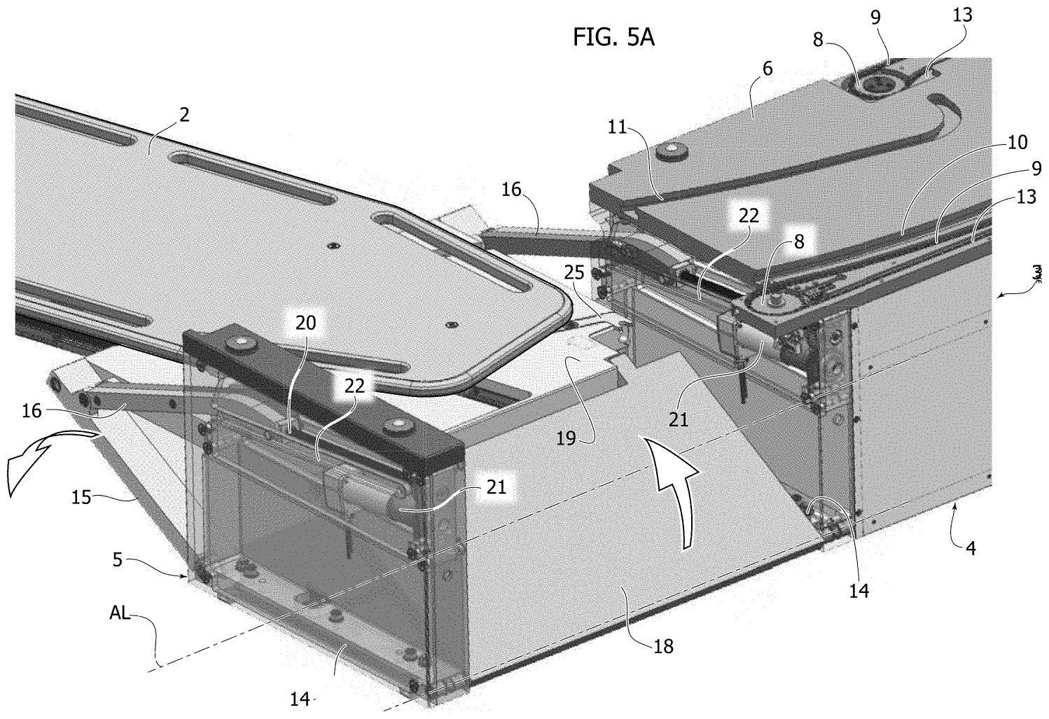

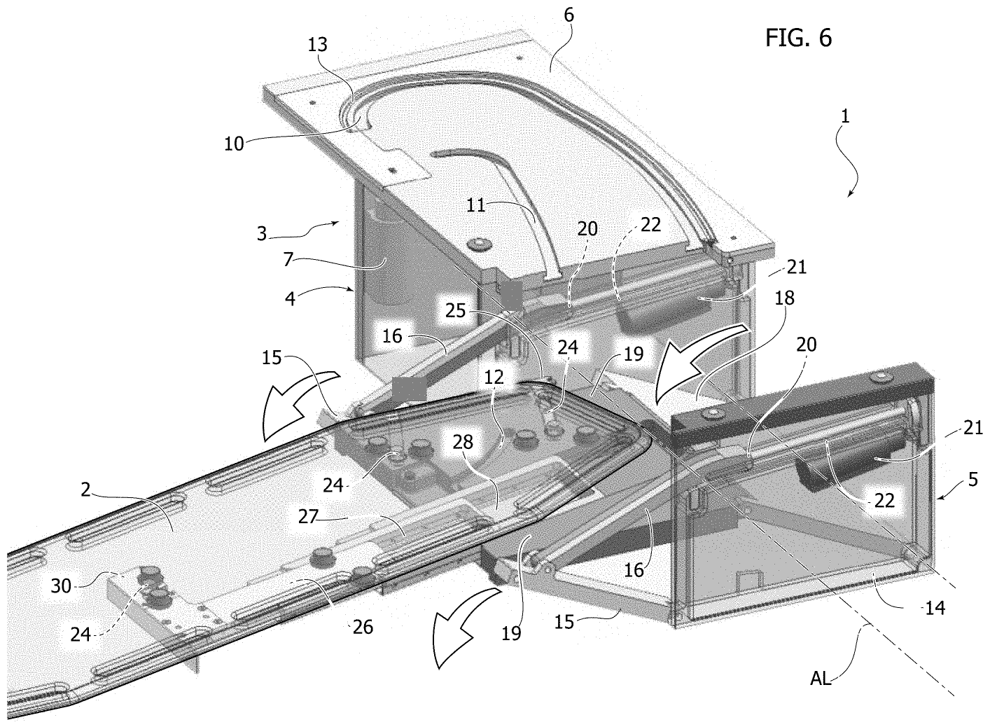

FIGS. 4A to 7 show the vertical displacement device 5 of the stretcher comprising the previously mentioned articulated quadrilateral mechanism.

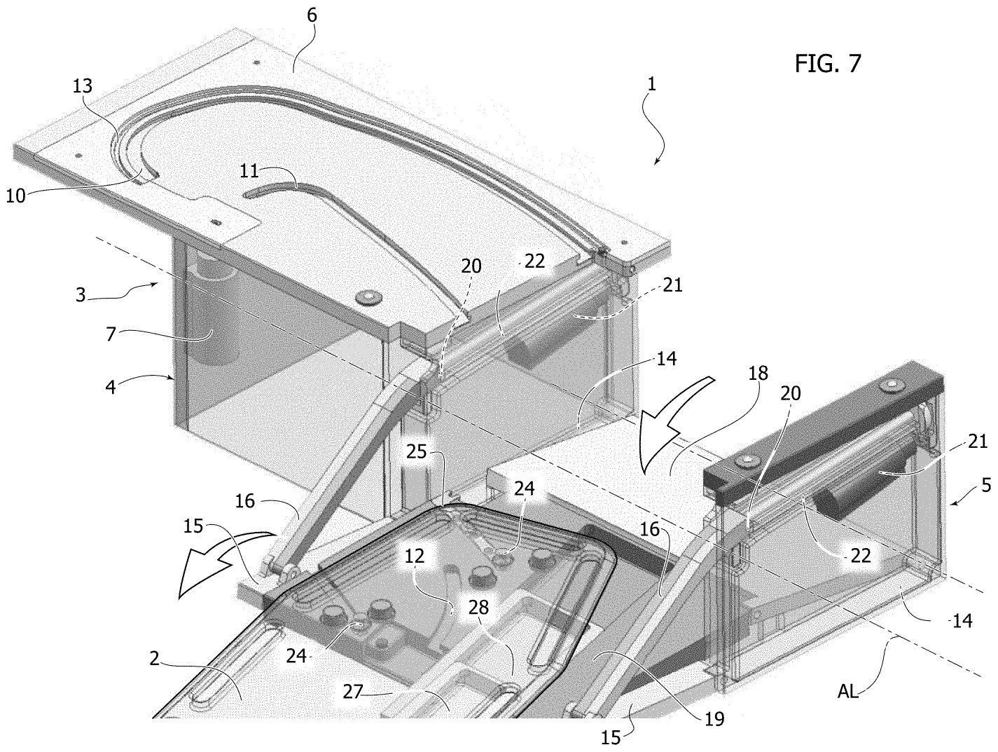

Such articulated quadrilateral mechanism comprises a pair of articulated arms 16 and a pair of lower fixed rods 14 fixed to the floor of the helicopter transversely to the longitudinal axis AL of the helicopter. Respectively articulated at the proximal ends of the fixed rods 14 are oscillating rods 15 rotatably actuated by the pair of arms 16 as it will be better explained subsequently. A quadrangular panel 18 is articulated—at the bottom part to the distal ends of the fixed rods 14 so as to be able to rotate between a substantially vertical position (better observable in FIG. 4A) and a substantially horizontal position (FIG. 7). A movable portion 19 of the horizontal platform 6 of the support structure 3 completes the articulated parallelogram mechanism being connected—on one part—to the upper side of the quadrangular panel 18 and—on the opposite part—to the oscillating rods 15.

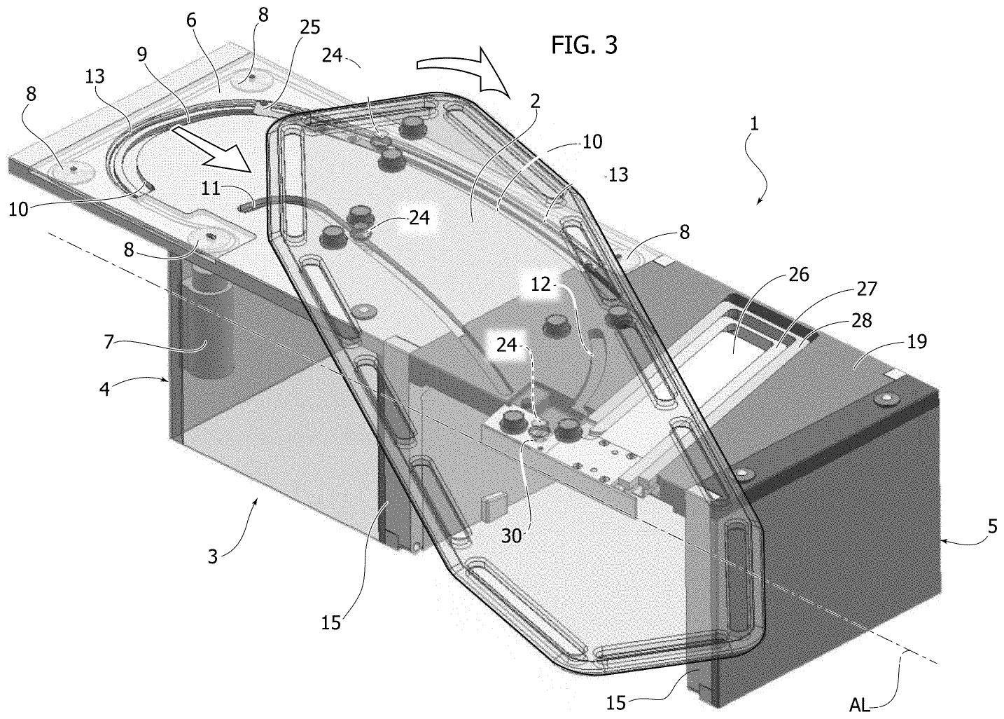

FIGS. 3 and 4 also show a telescopic device, provided in the movable portion 19 of the horizontal platform 6, comprising—in case of the illustrated example three slider-like box-shaped members 26, 27, 28 with progressively decreasing width and slidable one into the other between the retracted configuration of FIG. 2 and the extracted configuration of FIG. 4.

The box-shaped member 26 is provided, in the vacant end thereof, with a transversal bracket 30 bearing devices 24 for engagement with the support platform 2 so that the translation and rotation motion of the platform 2 actuates the telescopic device to support a portion of the platform 2 when removing from the helicopter cockpit.

The length of the oscillating rods 15 and the height of the quadrangular panel 18 are almost identical hence the movable portion 19 of the horizontal platform 6 is subjected, during the actuation of the articulated parallelogram mechanism by means of the pair of arms 16, to a vertical displacement remaining substantially parallel to the horizontal initial position.

Each arm 16 is articulated—at the outer end thereof—at the top part of the respective oscillating rod 15, while—at the opposite end—it is articulated to a screw and lead screw device 20 actuated by a respective electric motor 21 and movable in a respective track 22 provided for in the support structure 3.

The motor 7 (if present) and the motor 21 are actuated by means of an electronic control unit (not illustrated), conveniently arranged on board the handling device, in a sequential, coordinated and continuous manner as clarified hereinafter. The characteristics of the control unit are known to a man skilled in the art and does not require further specification.

Now described is the translation and rotation motion of the support structure 3 of the stretcher with reference to FIGS. 2 to 4A and 8 to 10.

Initially, the support structure 3 of the stretcher is arranged in a transportation position that is horizontal and parallel to the longitudinal axis AL of the helicopter, as visible in FIGS. 1 and 2.

Following the actuation of a special control of a control panel (not represented in the figures) the electronic control unit initially designated to control the activation of the electric motor 7 so as to actuate the chain 9 which, by means of the bracket 25, drives the support platform 2 which will move with an initial trajectory defined by the curvatures of the sliding guides 10, 11, 12. Such trajectory of the support platform 2, and thus the geometry of the sliding guides 10, 11, 12, are such that the stretcher, arranged on the support platform 2, does not interfere with the internal equipment or structures usually different for each type of helicopter.

The support platform 2 continues the translation and rotation motion until the engagement devices 24 reach the ends of the respective sliding guides 10, 11, 12 and the telescopic device 26, 27, 28 for supporting the platform 2 is driven by it up to reaching a fully extracted condition. At this point, the platform 2 is at the raised position for the maximum extracted part of the helicopter cockpit substantially transversely to the longitudinal axis AL while the distal portion of the platform 2 remains supported by the movable part 19 of the horizontal platform 6.

Following is a description of the vertical displacement of the stretcher.

At this point, the electronic control unit stops the rotation of the electric motor 7 and activates the electric motors 21, 21 of the arms 16 for displacing the articulated quadrilateral mechanism so as to start the vertical displacement of the movable portion 19 of the platform 6, and thus of the platform 2 supported by it, up to the lowered loading and unloading position in which the support platform 2 is arranged substantially at the same height as the floor of the helicopter cockpit, i.e. in a position suitable for transfer by hand-lifting the stretcher. In a first step of the vertical displacement the articulated bracket 25 of the support platform 2 is disconnected from the chain 9.

Once the patient has been loaded or unloaded with respect to the support platform 2, the latter can be returned from the lowered loading and unloading position to the transportation position by actuating the programmable electronic control unit so as to control the handling device described above in a synchronised fashion in the reverse direction with respect to the description outlined above.

The handling device 1 according to the invention is also conveniently provided with safety devices that can be activated in case of emergency, for example disconnection from electrical power supply, mechanical failure or malfunction of motor-driven handling means. Thus, the handling device may also provide for a manual actuation, not illustrated in that known to a man skilled in the art, to return the platform 6 to the transportation configuration.

The various parts of the system can also have mechanical interlocks or of another type, not illustrated in that also known to a man skilled in the art, which prevent the inadvertent movement thereof outside the correct sequence.

Mechanical safety devices suitable to displace the stretcher according to displacement sequences different other than the ones programmed in the programmable control unit can also be provided for. By way of example, using a single safety plug (not shown), that is easy to access and actuate, capable of preventing both the mechanical movement and electrical actuation if need be, could be provided for.

When using the handling device 1 according to the invention, all that is required of the operator is to control the displacement of the support platform of the stretcher by means of the control panel and supervise the actuation steps, and—without prejudice to the emergency procedures—the use of the device requires very limited training.

Furthermore, the stretcher is carried to project more from the helicopter cockpit with respect to a conventional handling device, thus allowing two people per side to near, on the ground, the stretcher.

Obviously, the construction details and the embodiments may widely vary with respect to what has been described and illustrated, without departing from the scope of protection of the present invention as defined in the claims that follow. Thus, for example, the general conformation of the handling device of the stretcher could be different from the one represented in the drawings.

1. A device for handling a helicopter stretcher comprising:
a platform for supporting the stretcher,
a bearing structure of said support platform,
handling means to carry out a translation and rotation motion of said platform,
said handling device being suitable to be installed in a helicopter cockpit for displacing said stretcher between a patient initial transportation position, in which the stretcher is arranged horizontally and parallel to a longitudinal axis of the helicopter on said support platform, and a patient loading and unloading position in which the stretcher is at least partially removed from the helicopter cockpit substantially transversely to said longitudinal axis,
said handling means include a vertical displacement device of the stretcher in said loading and unloading position between a raised condition and a lowered condition keeping the stretcher substantially horizontal,
a horizontal plate movably arranged on which is said support platform, said plate comprising a movable portion,
said translation and rotation motions of the stretcher are obtained through engagement means of the support platform suitable to be slidably coupled with curved sliding guides provided for on said horizontal plate,
said vertical displacement device comprises said movable portion, and
said movable portion being designed to remain substantially parallel to the initial position during the vertical displacement.

2. Handling device according to claim 1, wherein said vertical displacement device of the support platform of the stretcher is motor-driven.

3. Handling device according to claim 1, wherein said handling means of the support platform of the stretcher are motor-driven.

4. Handling device according to claim 3, further comprising an electronic control unit suitable to control said handling means and said vertical displacement device so that said translation, rotation and raising-lowering displacements of the stretcher are automated in a synchronized fashion.

5. Handling device according to claim 1, wherein said vertical displacement device of the stretcher comprises an articulated quadrilateral mechanism.

6. Handling device according to claim 5, wherein said articulated quadrilateral mechanism comprises a movable portion of the horizontal plate of the bearing structure including telescopic means suitable to support part of the support platform.

7. Handling device according to claim 1, further comprising a manual actuation for displacing the stretcher in case of failure of said motor-driven handling means.

8. Handling device according to claim 1, wherein safety means are provided to prevent the handling of the stretcher according to displacement sequences different from those actuated by said electronic control unit.

9. Handling device according to claim 1, further comprising a safety blocking device to inhibit handling of the stretcher.

10. Handling device according to claim 1, wherein said lowered loading and unloading position said support platform is substantially at the same height as the floor of the helicopter cockpit.

11. Handling device according to claim 2, wherein said handling means of the support platform of the stretcher are motor-driven.

12. Handling device according to claim 2, wherein said vertical displacement device of the stretcher comprises an articulated quadrilateral mechanism.

13. Handling device according to claim 3, wherein said vertical displacement device of the stretcher comprises an articulated quadrilateral mechanism.

14. Handling device according to claim 2, further comprising a manual actuation for displacing the stretcher in case of failure of said motor-driven handling means.

15. Handling device according to claim 3, further comprising a manual actuation for displacing the stretcher in case of failure of said motor-driven handling means.

16. Handling device according to claim 2, wherein safety means are provided to prevent the handling of the stretcher according to displacement sequences different from those actuated by said electronic control unit.

17. Handling device according to claim 2, further comprising a safety blocking device to inhibit handling of the stretcher.

18. Handling device according to claim 2, wherein said lowered loading and unloading position said support platform is substantially at the same height as the floor of the helicopter cockpit.
